(19) United States
(12) Patent Application Publication
(10) Pub. No.: US 2024/0343432 A1
(43) Pub. Date: Oct. 17, 2024

(54) PRESS-TYPE STRAPPING MACHINE WITH COMPRESSION SENSORS

(71) Applicant: Signode Industrial Group LLC, Tampa, FL (US)

(72) Inventors: Douglas Felsecker, Saint Charles, IL (US); Joel Patel, Hawthorn Woods, IL (US); Nicole Ostryzniuk, St. John, IN (US); Joseph Edward Lininger, Union Grove, WI (US)

(21) Appl. No.: 18/291,504

(22) PCT Filed: Jul. 29, 2021
(86) PCT No.: PCT/US2021/043613

§ 371 Date: Jan. 23, 2024

(51) Int. Cl. B65B 13/20; B30B 9/30; B65B 13/04

(52) U.S. Cl. CPC B65B 13/20; B30B 9/3007; B65B 13/04

(57) ABSTRACT

Various embodiments of the present disclosure provide a press-type strapping machine with compression sensors that enable the strapping machine to determine the applied compressive force the strapping machine applies to the load. The strapping machine includes a machine frame, a load supporter configured to support and move the load, a platen configured to compress the load against the load supporter, multiple compression sensors configured to sense compressive force, a strapping head configured to strap the load, and a controller configured to control the various components of the strapping machine. The compression sensors are mounted between the machine frame and the load supporter and are configured to send feedback representing detected compressive force to the controller. The controller is configured to use this feedback from the compression sensors to determine the compressive force the platen applies to the load.

### FIELD

The present disclosure relates to press-type strapping machines for compressing and strapping loads, and more particularly to press-type strapping machines with compression sensors that enable the strapping machine to determine the applied compressive force the strapping machine applies to the load.

### BACKGROUND

A strapping machine forms a tensioned loop of plastic strap (such as polyester or polypropylene strap) or metal strap (such as steel strap) around a load. A typical strapping machine includes a support surface that supports the load, a strap chute that defines a strap path and circumscribes the support surface, a strapping head that forms the strap loop and is positioned in the strap path, a controller that controls the strapping head to strap the load, and a frame that supports these components. To strap the load, the strapping head first feeds strap (leading strap end first) from a strap supply into and through the strap chute (along the strap path) until the leading strap end returns to the strapping head. While holding the leading strap end, the strapping head retracts the strap to pull the strap out of the strap chute and onto the load and tensions the strap to a designated strap tension. The strapping head then cuts the strap from the strap supply to form a trailing strap end and attaches the leading and trailing strap ends to one another, thereby forming a tensioned strap loop around the load. Certain strapping machines have multiple strapping heads and respective strap chutes that define respective strap paths. These strapping machines are configured to simultaneously form multiple tensioned strap loops (using strap from separate respective strap supplies) around a load.

Press-type strapping machines are configured to apply a compressive force to the load to partially compress the load, such as to partially compress a stack of flattened corrugated sheets, before strapping the load using multiple strapping heads. A typical press-type strapping machine includes a platen supported by the frame and vertically movable relative to the support surface and the load. Before strapping the load, the platen moves downward toward the support surface and into contact with the load. As the platen continues moving downward, it applies a compressive force to the load and starts compressing the load. As this occurs, the controller monitors the applied compressive force the platen applies to the load, and stops the platen once the applied compressive force reaches a target compressive force. At this point, the load is partially compressed, and the controller controls the strapping heads to strap the load. The platen then moves upward (away from the support surface and the load) to disengage the load and enable the load to be moved out of the strapping machine. As the platen moves upward and disengages the load, the load attempts to return to its original height by expanding upward. As this occurs, the strap loops stretch slightly ender this expansion force but prevent full expansion such that the strapped load is shorter than it was before compression and strapping but taller than it was when compressed. Compressing the loads before strapping not only makes the loads more compact and easier to store and handle, but also ensures the straps tightly bind the load together.

Certain known press-type strapping machines determine the compressive force applied to the load by monitoring the electrical current drawn by the platen actuator as it compresses the load and converting the electrical current value into a force value. The problem with this method is that it is not as accurate as certain operators would like, particularly for relatively low compressive force levels. This inaccuracy limits operators' ability to set relatively low target compressive forces and, therefore, their ability to optimally compress and strap certain loads.

### SUMMARY

Various embodiments of the present disclosure provide a press-type strapping machine with compression sensors that enable the strapping machine to determine the applied compressive force the strapping machine applies to the load. The strapping machine includes a machine frame, a load supporter configured to support and move the load, a platen configured to compress the load against the load supporter, multiple compression sensors configured to sense compressive force, a strapping head configured to strap the load, and a controller configured to control the various components of the strapping machine. The compression sensors are mounted between the machine frame and the load supporter and are configured to send feedback representing detected compressive force to the controller. The controller is configured to use this feedback from the compression sensors to determine the compressive force the platen applies to the load.

### BRIEF DESCRIPTION OF THE FIGURES

FIG. 1 is a perspective view of one example embodiment of a press-type strapping machine of the present disclosure.

FIG. 2 is a block diagram showing certain components of the press-type strapping machine of FIG. 1.

FIGS. 3A and 3B are perspective and top plan views, respectively, of the base of the machine frame of the press-type strapping machine of FIG. 1

FIGS. 4A, 4B, and 4C are top perspective, bottom perspective, and top plan views, respectively, of the load supporter of the press-type strapping machine of FIG. 1.

FIG. 5 is a perspective view showing one of the compression sensors of the press-type strapping machine of FIG. 1 between the machine frame and the load supporter.

FIG. 6 is a flowchart showing a method of operating a strapping machine of the present disclosure to carry out a strapping process.

### DETAILED DESCRIPTION

While the systems, devices, and methods described herein may be embodied in various forms, the drawings show and the specification describes certain exemplary and non-limiting embodiments. Not all of the components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as mounted, connected, etc., are not intended to be limited to direct mounting methods but should be interpreted broadly to include indirect and operably mounted, connected, and like mounting methods. This specification is intended to be taken as a whole and interpreted in accordance with the principles of the present disclosure and as understood by one of ordinary skill in the art.

Various embodiments of the present disclosure provide a press-type strapping machine with compression sensors that enable the strapping machine to determine the applied compressive force the strapping machine applies to the load. The strapping machine includes a machine frame, a load supporter configured to support and move the load, a platen configured to compress the load against the load supporter, multiple compression sensors configured to sense compressive force, a strapping head configured to strap the load, and a controller configured to control the various components of the strapping machine. The compression sensors are mounted between the machine frame and the load supporter and are configured to send feedback representing detected compressive force to the controller. The controller is configured to use this feedback from the compression sensors to determine the compressive force the platen applies to the load.

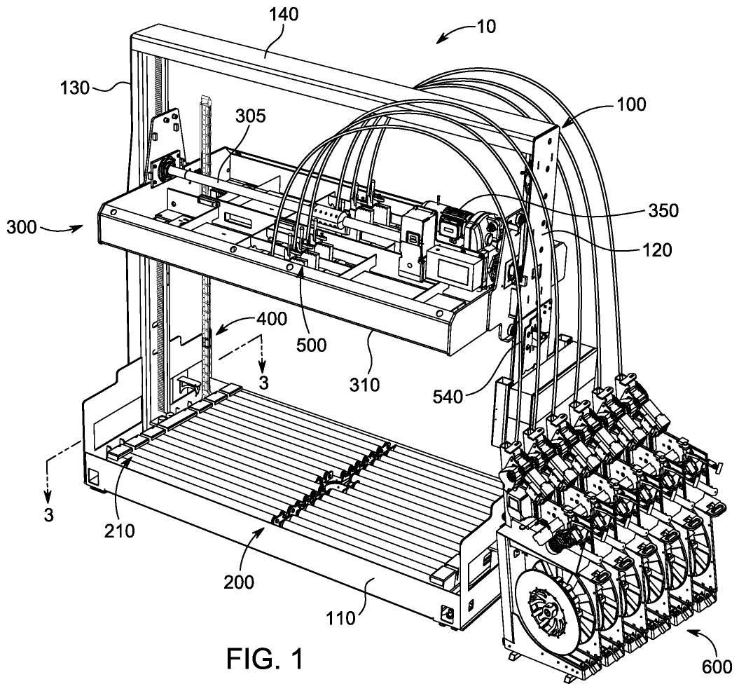

FIGS. 1-5 show one embodiment of the press-type strapping machine 10 of the present disclosure (referred to as the “strapping machine” below for brevity) and components thereof. The strapping machine 10 includes a machine frame 100; a load supporter 200; a platen 300; a platen actuator 350; multiple strap chutes 400 (only one of which is labeled for clarity); multiple strapping heads 500 (only one of which is labeled for clarity) each configured to draw strap from a respective strap supply 600 (only one of which is labeled for clarity); a distance sensor 700; first, second, third, and fourth compression sensors 750a, 750b, 750c, and 750d; and a controller 800.

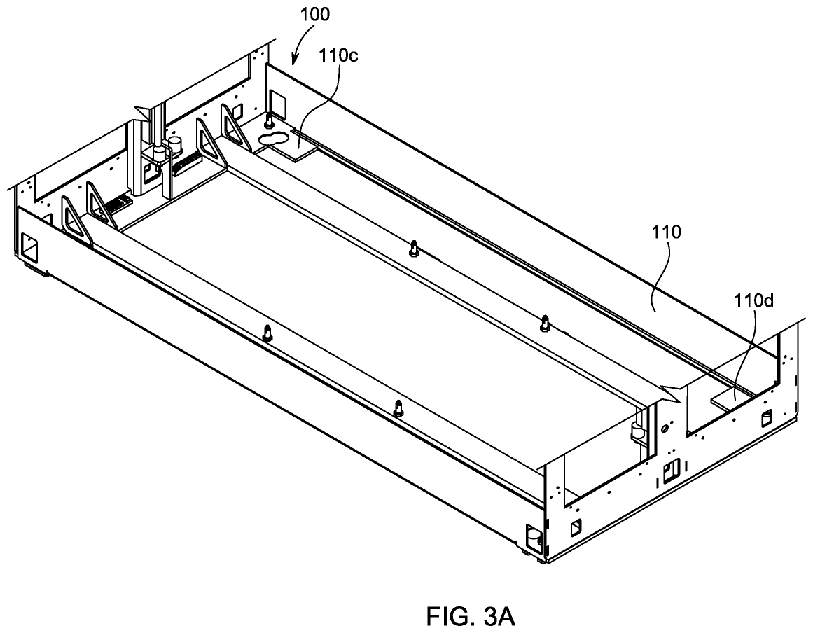

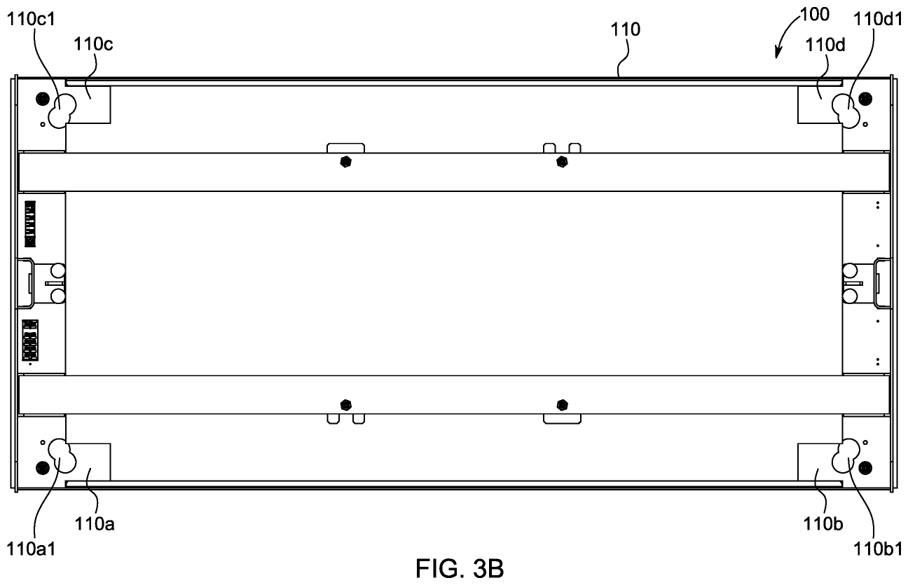

The machine frame 100, which is best shown in FIGS. 1, 3A, and 3B, is configured to support some (or in certain embodiments all) of the other components of the strapping machine 10. In this example embodiment, the machine frame 100 includes a base 110, first and second spaced-apart upstanding legs 120 and 130, and a connector 140 that spans and connects the upper ends of the first and second legs 120 and 130. As best shown in FIGS. 3A and 3B, the base 110 of the machine frame 100 includes first, second, third, and fourth compression-sensor mounts 110a, 110b, 110c, and 110d spaced in a rectangular configuration. The compression-sensor mounts 110a, 110b, 110c, and 110d include respective movement-restricting indentations 110a1, 110b1, 110c1, and 110d1, the purpose of which is explained below. Although not labeled, the first and second legs 120 and 130 each include a vertically extending toothed rack to enable the platen 300 to move relative to the first and second legs 120 and 320 in a rack-and-pinion fashion, as described below. This is merely one example of a configuration of components that form the machine frame 100, and any other suitable configuration of any other suitable components may form the machine frame 100 in other embodiments.

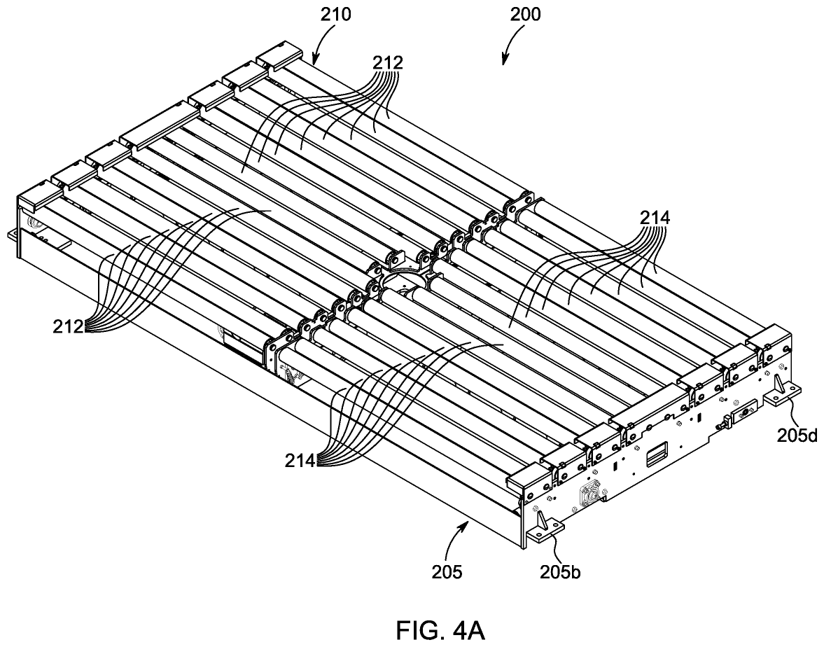

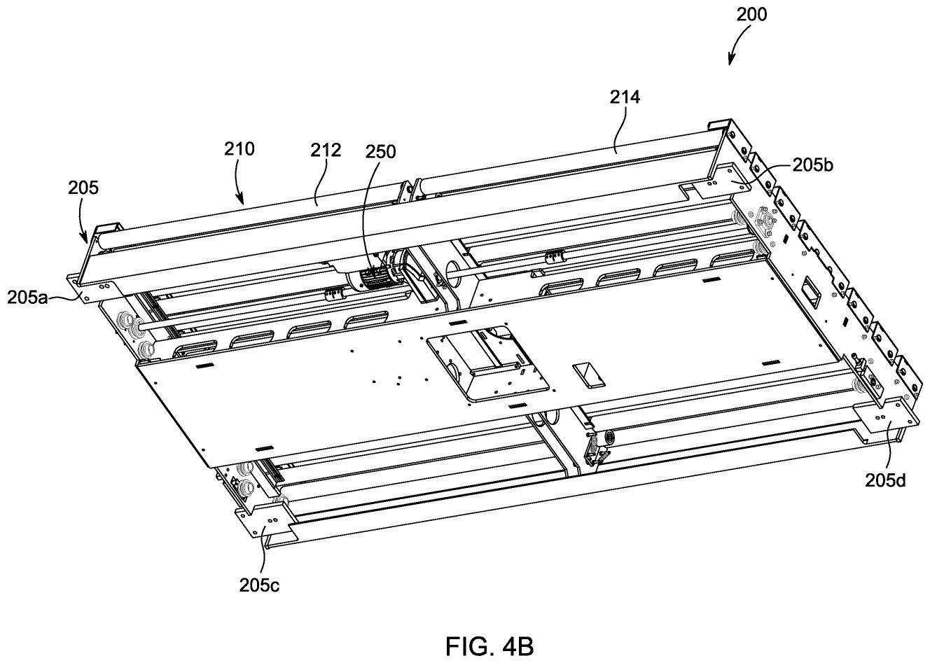

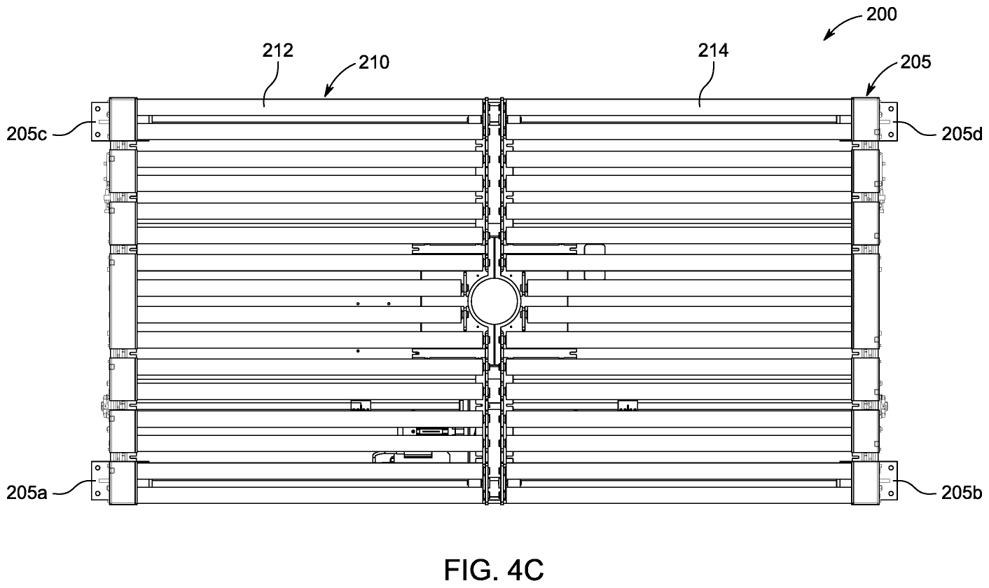

The load supporter 200, which is best shown in FIGS. 1 and 4A-4C, is configured to support and move loads through the strapping machine 10. The load supporter 200 includes a load-supporter frame 205 that includes first, second, third, and fourth compression-sensor mounts 205a, 205b, 205c, and 205d; a conveyor 210; and a conveyor actuator 250. The conveyor 210 is mounted to the load-supporter frame 205 and is configured to support loads during compression and strapping and to move loads through the strapping machine 10. In this example embodiment, the conveyor 210 includes first and second sets of aligned rollers 212 and 214. The conveyor actuator 250 is operably connected to the rollers 212 and 214-such as via gearing, chains, belts, and the like-to drive the rollers 212 and 214. The conveyor actuator 250 may be any suitable actuator, such as an electric, pneumatic, or hydraulic motor. The load supporter 200 is mounted to the base 110 of the machine frame 100 via the compression sensors 750a-750d (as described below) between the first and second legs 120 and 130 and below the connector 140.

The platen 300, which is shown in FIG. 1, is configured to apply a compressive force to the loads to partially compress them before strapping. The platen 300 is movably mounted to the first and second legs 120 and 130 of the machine frame 100 above the load supporter 200 and is vertically movable relative to the load supporter 200 so the platen 300 can adjust to loads of different heights and apply a compressive force to the loads. In this example embodiment, the platen 300 includes two rotatable pinions (not shown) fixed to a pinion shaft 305 such that the pinions and the pinion shaft 305 rotate together. The pinion shaft 305 extends between the first and second legs 120 and 130 such that one pinion meshes with the toothed rack in the first leg 120 and the other pinion meshes with the toothed rack in the second leg 130. In this configuration, rotation of the pinions (which rotate together via their fixed connection to the pinion shaft 305) under control of the platen actuator 350 (described below) causes the pinions to climb or descend their respective toothed racks such that the platen 300 moves away from or toward the conveyor 210 of the load supporter 200 (i.e., upward or downward, as described in more detail below). The platen 300 also includes one or more compression surfaces 310 on its underside for contacting and applying the compressive force to the load.

The platen actuator 350 is any suitable actuator, such as an electric, pneumatic, or hydraulic motor, operably connected to the platen 300 to move the platen 300 relative to the first and second legs 120 and 130 toward and away from the conveyor 210 of the load supporter 200 (i.e., downward and upward). In this example embodiment, the platen actuator 350 is operably connected to the pinions and the pinion shaft 305 of the platen 300 via gearing (not shown) such that rotation of an output shaft (not shown) of the platen actuator 350 results in rotation of the pinions (and the pinion shaft 305) and vertical movement of the platen 300. In one example embodiment, an output gear (not shown) of the gearing is meshed with one of the pinions such that rotation of the output gear (caused by rotation of the output shaft of the platen actuator 350) directly causes that pinon to rotate, which in turn causes the pinion shaft 305 and the other pinion to rotate. Rotating the output shaft of the platen actuator 350 in one direction results in movement of the platen 300 away from the conveyor 210, and rotation of the output shaft in the opposite direction results in movement of the platen 300 toward the conveyor 210. This is merely one example embodiment of the platen actuator, and any suitable actuator may be employed. Additionally, any other suitable manner of controlling vertical movement of the platen 300 may be employed (e.g., hydraulic or pneumatic cylinders, belt-and-pulley assemblies, and the like), as the rack-and-pinion configuration is merely one example embodiment.

The strap chute 400 circumscribes the conveyor 210 and defines a strap path that the strap follows when fed through the strap chute 400 and from which the strap is removed when retracted. The strap chute 400 includes two spaced-apart first and second upstanding legs (not labeled), an upper connecting portion (not shown) that spans the first and second legs and is positioned in the platen 300, a lower connecting portion (not shown) that spans the first and second legs and is positioned in the load supporter 200, and elbows that connect these portions. As is known in the art, the radially inward wall of the strap chute 400 is formed from multiple overlapping gates that are spring biased to a closed position that enables the strap to traverse the strap path when fed through the strap chute 400. When the strapping head 500 later exerts a pulling force on the strap to retract the strap, the pulling force overcomes the biasing force of the springs and causes the gates to pivot to an open position, thereby releasing the strap from the strap chute so the strap contacts the load as the strapping head 500 continues to retract the strap.

The strapping head 500 is configured to form a tensioned strap loop around the load by feeding the strap through the strap chute 400 along the strap path, holding the leading strap end while retracting the strap to remove it from the strap chute 400 so it contacts the load, tensioning the strap around the load to a designated tension, cutting the strap from the strap supply to form a trailing strap end, and connecting the leading strap end and trailing strap end to one another. In this example embodiment, the strapping head 500 is a modular strapping head including independently removable and replaceable feed, tensioning, and sealing modules 510, 520, and 530. The feed module 510, which is configured to feed and retract the strap, and the tensioning module 520, which is configured to tension the strap, are mounted to a frame (not labeled) of the strap supply 600. That is, in this example embodiment, the feed and tensioning modules 510 and 520 are located remote from the strapping machine 10 (though in other embodiments the feed and/or tensioning modules 510 and 520 may be supported by the machine frame 100, the platen 300, or any other suitable component of the strapping machine 10). The platen 300 supports the sealing module 530, which is configured to hold the leading strap end, cut the strap from the strap supply, and connect the leading strap end and trailing strap end to one another. A strap guide 540 extends between the feed and tensioning modules 510 and 520 and the sealing module 530 and is configured to guide the strap as it moves between the modules.

This is merely one example strapping head, and the strapping machine 10 may include any suitable modular strapping head or non-modular strapping head (i.e., a strapping head that is not comprised of independently removable and replaceable feed and sealing modules). The manner of attaching the leading and trailing strap ends to one another depends on the type of strapping machine and the type of strap. Certain strapping machines configured for plastic strap include strapping heads with friction welders, heated blades, or ultrasonic welders configured to attach the leading and trailing strap ends to one another. Some strapping machines configured for plastic strap or metal strap include strapping heads with jaws that mechanically deform (referred to as “crimping” in the industry) or cut notches into (referred to as “notching” in the industry) a seal element positioned around the leading and trailing strap ends to attach them to one another. Other strapping machines configured for metal strap include strapping heads with punches and dies configured to form a set of mechanically interlocking cuts in the leading and trailing strap ends to attach them to one another (referred to in the strapping industry as a “sealless” attachment). Still other strapping machines configured for metal strap include strapping heads with spot, inert-gas, or other welders configured to weld the leading and trailing strap ends to one another.

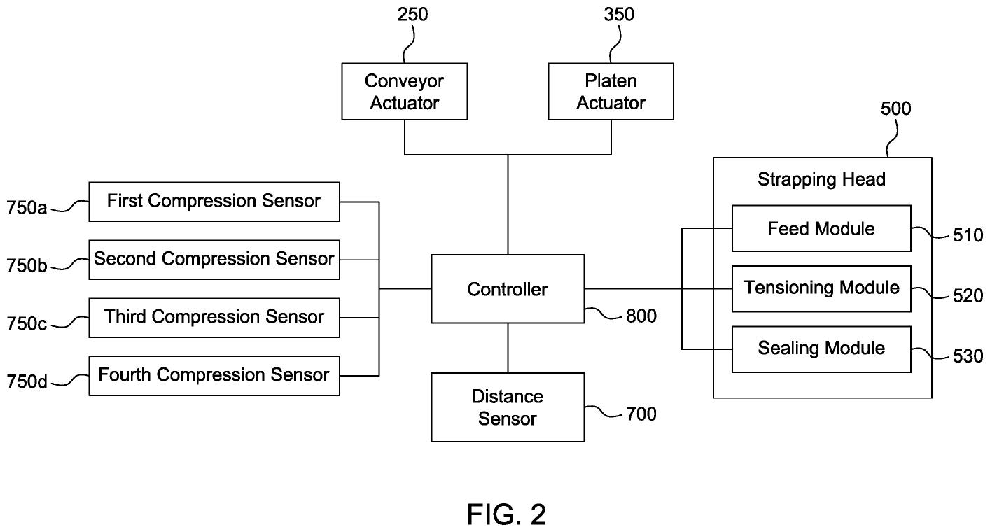

The distance sensor 700 (FIG. 2) is mounted to the underside of the connector 140 of the machine frame 100 and is configured to detect the vertical distance between the distance sensor 700 and the platen 300. The controller 800 uses feedback from the distance sensor 700 to determine the position of the platen 300 above the conveyor 210 of the load supporter 200. In this example embodiment, the distance sensor 700 is a laser sensor, and a reflector is mounted to an upper surface of the platen 300 such that the distance sensor 700 is configured to measure the distance between the distance sensor 700 and the reflector on the platen 300. The distance sensor may be any other suitable sensor, such as an ultrasonic sensor, an infrared sensor, a time-of-flight sensor, or an encoder. Additionally, while in this example embodiment the distance sensor is configured to measure the distance between itself and the platen (and more specifically, the reflector on the platen), the distance sensor may be configured to measure any suitable distance that can be used to directly or indirectly determine the distance between the platen and the support surface (such as the distance between the platen and any other stationary component of the strapping machine, including the support surface itself).

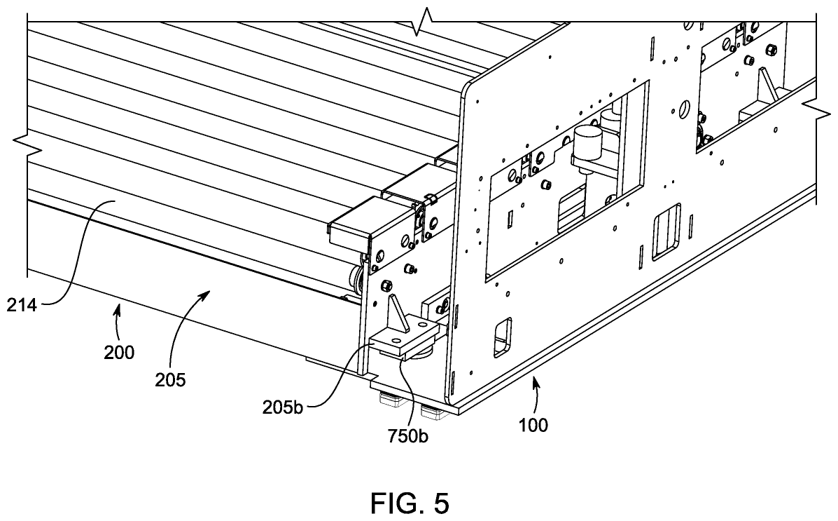

The compression sensors 750a-750d are mounted between the machine frame 100 and the load supporter 200 and configured to sense compressive force. In this example embodiment the compression sensors are load cells, though they may be any other suitable sensors in other embodiments, such as strain gauges, compression force gauges, or torque gauges. The first compression sensor 750a is mounted between the first compression-sensor mount 110a of the base 110 of the machine frame 100 and the first compression-sensor mount 205a of the load-supporter frame 205 of the load supporter 200, the second compression sensor 750b is mounted between the second compression-sensor mount 110b of the base 110 and the second compression-sensor mount 205b of the load-supporter frame 205, the third compression sensor 750c is mounted between the third compression-sensor mount 110c of the base 110 and the third compression-sensor mount 205c of the load-supporter frame 205, and the fourth compression sensor 750d is mounted between the fourth compression-sensor mount 110d of the base 110 and the fourth compression-sensor mount 205d of the load-supporter frame 205. Part of each compression sensor is received in the movement-restricting indentation of its respective compression-sensor mount of the base and is sized and shaped such that the walls of the movement-restricting indentation prevent substantial (or all) lateral movement (movement within the plane of the page from the perspective shown in FIG. 3B) of the compression sensor relative to the machine frame. The compression sensors may be mounted to their respective mounts in any suitable manner, such as via fasteners, a press fit, couplings, and the like. FIG. 5 shows the second compression sensor 750b mounted between the machine frame 100 and the load supporter 200; the others are mounted in a similar manner. While this example strapping machine 10 includes four compression sensors, other embodiments of the strapping machine may include any suitable quantity of one or more compression sensors.

In this example embodiment, the load supporter 200 is floatingly mounted to the machine frame 100 via the compression sensors 750a-750d such that the compression sensors 750a-750d carry the entire weight of the load supporter 200 and any load on the load supporter 200 and are also subjected to the compression force the platen 300 applies to the load. In other words, the floating mount configuration results in the compressive force generated by the mass of the load, the compressive force generated by the mass of the load supporter 200, and the compressive force applied by the platen 300 being exerted on the compression sensors 750a-750d. As described below, this enables the controller 800 to accurately determine the applied compressive force the platen 300 applies to the load, even when the applied compressive force is relatively low. This ability to accurately determine the applied compressive force via feedback from the compression sensors solves the above problems with the prior art's relatively inaccurate method of indirectly determining the applied compressive force.

The controller 800 includes a processing device (or devices) communicatively connected to a memory device (or devices). For instance, the controller may be a programmable logic controller. The processing device may include any suitable processing device such as, but not limited to, a general-purpose processor, a special-purpose processor, a digital-signal processor, one or more microprocessors, one or more microprocessors in association with a digital-signal processor core, one or more application-specific integrated circuits, one or more field-programmable gate array circuits, one or more integrated circuits, and/or a state machine. The memory device may include any suitable memory device such as, but not limited to, read-only memory, random-access memory, one or more digital registers, cache memory, one or more semiconductor memory devices, magnetic media such as integrated hard disks and/or removable memory, magneto-optical media, and/or optical media. The memory device stores instructions executable by the processing device to control operation of the strapping machine 10, such as to carry out the strapping process 1000 described below.

The controller 800 is communicatively and operably connected to the conveyor actuator 250, the platen actuator 350, and the strapping head 500 to receive signals from and to control those components. The controller 800 is communicatively connected to the distance sensor 700 and the compression sensors 750a-750d to receive feedback (e.g., signals) from these sensors. As described below, the controller 800 is configured to control the conveyor actuator 250, the platen actuator 350, and the strapping head 500 responsive to signals received from the conveyor actuator 250, the platen actuator 350, the distance sensor 700, and the compression sensors 750a-750d (depending on the implementation).

The controller 800 is configured to determine the applied compressive force the platen 300 applies to the load based on feedback received from the compression sensors 750a-750d. Specifically, after a load is introduced atop the conveyor 210 and below the platen 300 into a strapping area of the strapping machine 10, the controller 800 determines the combined compressive force exerted on the compression sensors 750a-750d based on feedback from the compression sensors 750a-750d. At this point, this combined compressive force represents the combined force the load and the load supporter 200 exert on the compression sensors 750a-750d via their combined mass-in other words, the combined weight of the load and the load supporter 200. The compression sensors 750a-750d each detect a portion of that combined compressive force (which may or may not be the same for all four sensors) and send respective feedback (e.g., force readings) to the controller 800. The controller 800 sums these readings to determine the combined compressive force. For example, a load is introduced into the strapping area of the strapping machine 10 atop the load supporter 200. The first compression sensor 750a detects a 498 Newton force and sends appropriate feedback to the controller 800. The second compression sensor 750b detects a 502 Newton force and sends appropriate feedback to the controller 800. The third compression sensor 750c detects a 505 Newton force and sends appropriate feedback to the controller 800. The fourth compression sensor 750d detects a 495 Newton force and sends appropriate feedback to the controller 800. The controller 800 uses the combined feedback (such as by summing the force readings) to determine the combined 2,000 Newton compressive force exerted on the compression sensors 750a-750d by the load and the load supporter 200.

After the platen 300 contacts the load, the combined compressive force exerted on the compression sensors 750a-750d increases due to the addition of the applied compressive force of the platen (which adds to the force the load and the load supporter 200 already exert on the compression sensors 750a-750d). During compression, the compression sensors 750a-750d periodically detect a portion of that combined compressive force (which again may or may not be the same for all four sensors) and send respective feedback (e.g., force readings) to the controller 800. The controller 800 sums these readings to determine the combined compressive force. The controller determines the applied compressive force that the platen 300 applies to the load by determining the difference between the combined compressive force and the compressive force the load and the load supporter 200 exert on the compression sensors 750a-750d (i.e., the combined weight of those components). Continuing with the above example, after the platen 300 contacts the load, the first compression sensor 750a detects a 748 Newton force and sends an appropriate force reading to the controller 800. The second compression sensor 750b detects a 752 Newton force and sends an appropriate force reading to the controller 800. The third compression sensor 750c detects a 755 Newton force and sends an appropriate force reading to the controller 800. The fourth compression sensor 750d detects a 745 Newton force and sends an appropriate force reading to the controller 800. The controller 800 sums these readings to determine the combined 3,000 Newton compressive exerted on the compression sensors 750a-750d by the load, the load supporter 200, and the platen 300. The controller determines an applied compressive force of 1,000 Newtons by determining the difference between the combined 3,000 Newton compressive force and the 2,000 Newton compressive force applied by the load and the load supporter 200.

In other embodiments, the controller zeroes (or tares) the compression sensors after the load is positioned in the strapping area. In these embodiments, after zeroing the compression sensors no longer detect the weight of the load supporter or the load, so the applied compressive force is equal to the force reading received from the compression sensors. For instance, using the above example, a load is introduced into the strapping area of the strapping machine atop the load supporter. The first compression sensor detects a 498 Newton force and sends appropriate feedback to the controller. The second compression sensor detects a 502 Newton force and sends appropriate feedback to the controller. The third compression sensor detects a 505 Newton force and sends appropriate feedback to the controller. The fourth compression sensor detects a 495 Newton force and sends appropriate feedback to the controller. The controller zeroes (or tares) the compression sensors. After the platen contacts the load, the first compression sensor detects a 250 Newton force and sends an appropriate force reading to the controller. The second compression sensor detects a 250 Newton force and sends an appropriate force reading to the controller. The third compression sensor detects a 250 Newton force and sends an appropriate force reading to the controller. The fourth compression sensor detects a 250 Newton force and sends an appropriate force reading to the controller. The controller sums these readings to determine an applied compressive force of 1,000 Newtons.

The controller 800 is configured to determine the position of the platen 300 above the conveyor 210 of the load supporter 200 based on a distance reading received from the distance sensor 700 in a suitable manner, such as via lookup table correlating the measured distance with the distance separating the platen and the conveyor.

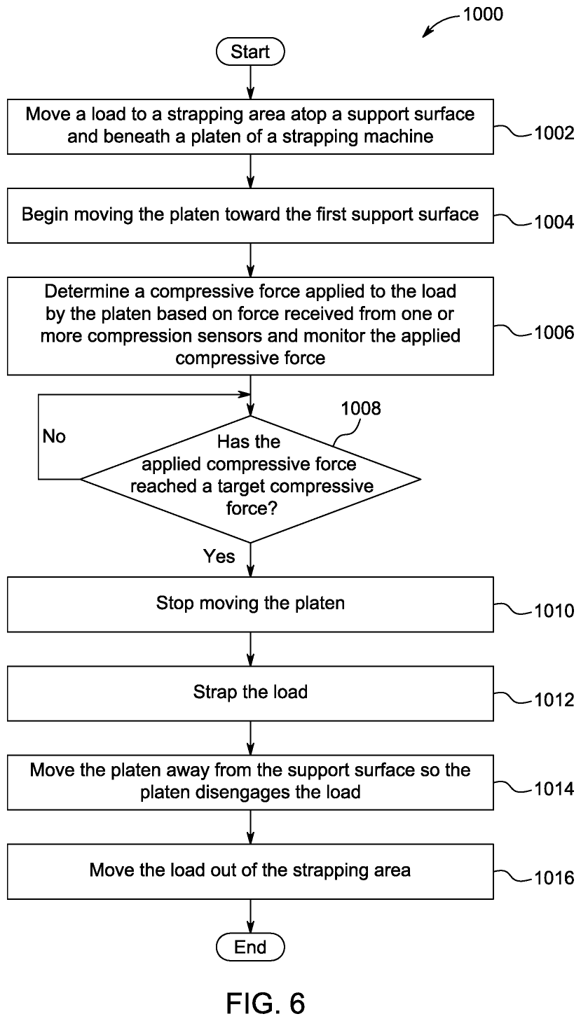

Operation of the strapping machine 10 to conduct a strapping process 1000 (sometimes referred to below as the “process 1000” for brevity) to strap a load is now described in conjunction with the flowchart shown in FIG. 6. To start the process 1000, the load is moved to a first strapping area atop the conveyor 210 and beneath the platen 300 of the first strapping machine 10, as block 1002 indicates. The controller 800 controls the platen actuator 350 to begin moving the platen 300 toward the conveyor 210 and (eventually) into contact with the load, as block 1004 indicates. As this occurs, the controller 800 determines the compressive force applied to the load based on force feedback received from the compression sensors 750a-750d and monitors the applied compressive force, as block 1006 indicates and as described above. The controller 800 monitors the applied compressive force to determine whether the applied compressive force has reached a target compression force, as diamond 1008 indicates. The target compression force may be any suitable force set by the operator or otherwise. Once the controller 800 determines that the applied compressive force has reached the target compression force, the controller 800 controls the platen actuator 350 to stop moving the platen 300, as block 1010 indicates. The controller 800 controls the strapping head(s) 500 to strap the load, as block 1012 indicates. The controller 800 then controls the platen actuator 350 to move the platen 300 away from the conveyor 210 so the platen disengages the load, as block 1014 indicates, and the load is then moved out of the strapping area, as block 1016 indicates.

1. A strapping machine for compressing and strapping a load, the strapping machine comprising:
a machine frame;
one or more compression sensors configured sense compressive force;
a load supporter comprising a conveyor and mounted to the one or more compression sensors;
a platen supported by the machine frame and movable toward and away from the load supporter;
a strapping head; and
a controller configured to:
control the platen to move toward the load supporter and a load positioned on the conveyor and beneath the platen;
determine an applied compressive force the platen applies to the load based on feedback from the one or more compression sensors; and
responsive to the applied compressive force reaching a target compressive force, stop moving the platen toward the load supporter and control the strapping head to strap the load.

2. The strapping machine of claim 1, wherein the controller is further configured to:
determine a combined compressive force based on the feedback from the one or more compression sensors; and
determine the applied compressive force based on a weight of the load supporter, a weight of the load, and the combined compressive force.

3. The strapping machine of claim 2, wherein the controller is further configured to determine the applied compressive force by determining the difference between the combined compressive force and the combined weights of the load supporter and the load.

4. The strapping machine of claim 2, wherein the controller is further configured to, before the platen contacts the load, determine at least one of the weight of the load supporter and the weight of the load based on feedback from the one or more compression sensors.

5. The strapping machine of claim 1, wherein the controller is further configured to, before the platen contacts the load, zero the one or more compression sensors such that the feedback from the one or more compression sensors represents the applied compressive force.

6. The strapping machine of claim 1, wherein the one or more compression sensors are mounted between the machine frame and the load supporter.

7. The strapping machine of claim 6, wherein the load supporter further comprises a load-supporter frame to which the conveyor is mounted, wherein the one or more compression sensors are mounted between the machine frame and the load-supporter frame.

8. The strapping machine of claim 7, wherein the one or more compression sensors comprise first, second, third, and fourth compression sensors mounted between the machine frame and the load-supporter frame.

9. The strapping machine of claim 8, wherein the machine frame comprises first, second, third, and fourth compression-sensor mounts, wherein the load-supporter frame comprises first, second, third, and fourth compression-sensor mounts, wherein the first compression sensor is mounted between the first compression-sensor mounts, wherein the second compression sensor is mounted between the second compression-sensor mounts, wherein the third compression sensor is mounted between the third compression-sensor mounts, wherein the fourth compression sensor is mounted between the fourth compression-sensor mounts.

10. The strapping machine of claim 9, wherein the load-supporter frame is rectangular and comprises four corners, wherein the first, second, third, and fourth compression-sensor mounts are each positioned adjacent a different one of the corners.

11. The strapping machine of claim 1, wherein the one or more compression sensors comprise one or more load cells.

12. The strapping machine of claim 1, wherein the load supporter is mounted to the one or more compression sensors such that the one or more compression sensors support the entire weight of the load supporter and the entire weight of the load and are subjected to the applied compressive force.

13. A strapping machine for compressing and strapping a load, the strapping machine comprising:
a machine frame;
multiple compression sensors configured to sense compressive force;
a load supporter floatingly mounted to the machine frame via the compression sensors such that the compression sensors support the entire weight of the load supporter;
a platen supported by the machine frame;
a platen actuator operably connected to the platen and configured to move the platen toward and away from the load supporter; and
a strapping head configured to strap the load.

14. The strapping machine of claim 13, wherein the strapping machine further comprises a controller configured to:
control the platen actuator to move the platen toward the load supporter and a load positioned on the conveyor and beneath the platen;
determine an applied compressive force the platen applies to the load based on feedback from the compression sensors; and
responsive to the applied compressive force reaching a target compressive force, stop moving the platen toward the load supporter and control the strapping head to strap the load.

15. The strapping machine of claim 13, wherein the load supporter further comprises a rectangular load-supporter frame comprising four corners, wherein the compression sensors comprise first, second, third, and fourth compression sensors each positioned adjacent a different one of the corners.

16. The strapping machine of claim 14, wherein the machine frame comprises a base comprising first, second, third, and fourth compression-sensor mounts, wherein the first, second, third, and fourth compression sensors are mounted to the first, second, third, and fourth compression-sensor mounts, respectively.

17. The strapping machine of claim 16, wherein the first, second, third, and fourth compression-sensor mounts define respective movement-restricting indentations, wherein part of each of the first, second, third, and fourth compression sensors is received in the first, second, third, and fourth movement-restricting indentations, respectively.

18. The strapping machine of claim 17, wherein the first, second, third, and fourth movement-restricting indentations are sized and shaped relative to the first, second, third, and fourth compression sensors to restrict lateral movement of the respective compression sensors relative to the machine frame.

19. The strapping machine of claim 18, wherein the parts of the first, second, third, and fourth compression sensors received in the first, second third, and fourth movement-restricting indentations are disc shaped.
